(19) United States
(12) Patent Application Publication
(10) Pub. No.: US 2009/0210778 A1
(43) Pub. Date: Aug. 20, 2009

(54) VIDEO LINKING TO ELECTRONIC TEXT MESSAGING

(76) Inventors: Charles J. Kulas, San Francisco, CA (US); Lee C. Evans, Los Angeles, CA (US)

Correspondence Address: CHARLES J. KULAS, 651 ORIZABA AVE., SAN FRANCISCO, CA, 94132, US

(21) Appl. No.: 12/388,421

(22) Filed: Feb. 18, 2009

Related U.S. Application Data
(60) Provisional application No. 61/029,918, filed on Feb. 19, 2008.

(51) Int. Cl. G06F 17/00; G06F 3/048

(52) U.S. Cl. 715/201; 715/758; 715/719

(57) ABSTRACT

Certain embodiments of the invention include methods and apparatuses for linking video information to electronic messages such as electronic mail (email), online chat, web logs (“blogs”), bulletin boards, web page text, Simple Mobile Services (SMS), Multimedia Messaging Service (MMS) and other electronic message formats. One embodiment provides for embedding links from a video annotation session at a cursor position in an email application. A method for transferring from email to chat and vice versa is disclosed whereby association with video content is maintained.

### CLAIM OF PRIORITY

This application claims priority from U.S. Provisional Patent Application Ser. No. 61/029,918 filed on Feb. 19, 2008, attorney docket No. CJK-33 entitled “VIDEO LINKING TO ELECTRONIC TEXT MESSAGING” which is hereby incorporated by reference as if set forth in this application in full for all purposes.

### CROSS-REFERENCE TO RELATED APPLICATIONS

This application is related to co-pending U.S. patent application Ser. No. 11/868,524 filed on Oct. 7, 2007, attorney docket No. CJK-32, entitled “USER INTERFACE FOR CREATING TAGS SYNCHRONIZED WITH A VIDEO PLAYBACK” which is hereby incorporated by reference as if set forth in this application in full for all purposes.

### BACKGROUND OF THE INVENTION

This disclosure relates generally to electronic messaging and more specifically to systems, methods, and interfaces for affecting or controlling electronic message content.

Existing electronic messaging systems and associated interfaces often lack desirable functionality for manipulating or annotating content, such as video content, in an electronic message.

### BRIEF DESCRIPTION OF THE DRAWINGS

FIG. 1 shows a first user interface screen for an email application according to a first example embodiment.

FIG. 2 shows a second user interface screen after a user has selected the video-link icon of the interface of FIG. 1.

FIG. 3 shows a third user interface screen after a user has inserted vubble annotations into to the video linked via the interface of FIG. 2.

FIG. 4 shows a fourth user interface screen with video links after a recipient has received the electronic message shown in the interface of FIG. 3.

FIG. 5 shows a fifth user interface screen as can appear in a new or existing chat messaging session employing video linking according to a second example embodiment.

FIG. 6 shows a sixth user interface as can appear after a recipient has selected to watch a video linked via the chat message of FIG. 5.

FIG. 7 illustrates a flowchart of a routine to provide an annotated video associated with an electronic message, wherein the routine is suitable for use with the embodiments of FIGS. 1-6.

FIG. 8 shows a seventh user interface screen according to a third example embodiment.

FIG. 9 shows an eighth user interface screen including a vubble interface for use with the third example embodiment.

FIG. 10 shows a ninth user interface screen illustrating vubble paste, i.e., insert functionality for use with the third example embodiment.

FIG. 11 shows a tenth user interface screen after a recipient has received the electronic message shown in the third interface of FIG. 10.

FIG. 12 shows a eleventh user interface screen with a vubble indicator area after the original sender receives the reply message shown in FIG. 11.

FIG. 13 shows a twelfth user interface screen with a vubble-insert icon according to a fourth embodiment.

FIG. 14 shows a thirteenth user interface screen illustrating a vubble-authoring tool activated via the vubble-insert icon of FIG. 13.

FIG. 15 shows a fourteenth user interface screen illustrating the vubble-authoring tool of FIG. 14 after a user has selected the create-vubble control thereof.

FIG. 16 shows a fifteenth user interface screen illustrating the vubble-authoring tool of FIG. 15 after a user has inserted, i.e., pasted, a created vubble into a video display area.

FIG. 17 shows a sixteenth user interface screen illustrating an electronic message incorporating a vubbled video or link thereto ready to be sent to a recipient according to the fourth embodiment.

FIG. 18 shows a seventeenth user interface screen illustrating an email thread incorporating the vubble of FIG. 17 and a vubble newly created by a recipient of the electronic message of FIG. 17.

FIG. 19 illustrates a flowchart of a routine adapted for use with the embodiments of FIGS. 8-19.

### DETAILED DESCRIPTION OF EXAMPLE EMBODIMENTS

For the purposes of the present discussion, a video, also called video content, may be any sequence of images adapted to be displayed successively. An image may be any data that may be rendered graphically or may be the graphical representation of the data itself. Hence, a digital movie, film clip, animation, electronic slide show, electronic comic strip, and so on, are considered to represent examples of videos.

A video tag, also called a “video bubble” or “vubble,” may be any content used to augment or overlay video data. Examples of vubble content include text, hyperlinks, audio, animations, program icons, image maps, and so on. A tag may be any auxiliary digital-media content, including auxiliary content to applied to image data, such as video or a still frame of a video. Hence, a vubble is a type of tag. For the purposes of the present discussion, auxiliary content may be any data or functionality, such as comments, hyperlinks, and so on, that augments other content.

Properties or characteristics of a vubble may be anything associated with a vubble, including but not limited to vubble content, such as text, behavior of the vubble, such as animation behavior and display duration and location, and display qualities of the vubble, such as color, transparency, and pointer positioning. Vubble content may be any auxiliary content included in, linked to, or otherwise associated with or accessible via a video tag.

An electronic message may be any message adapted to be sent via a communications network. Examples of communications networks include packet-switched networks, such as the Internet, circuit-switched networks, such as the Public Switched Telephone Network (PSTN), and wireless networks, such as a Code Division Multiple Access (CDMA), Global System for Mobile communications (GSM), Analog Mobile Phone System (AMPS), Time Division Multiple Access (TDMA) or other network. Hence, a telephone call, teleconference, web conference, video conference, a text message exchange, and so on, fall within the scope of the definition of an electronic message.

An email may be a specific type of electronic message adapted to be sent via Simple Mail Transfer Protocol (SMPT), Internet Message Access Protocol (IMAP), and/or other email protocol. A chat message may be any electronic message adapted to be sent via an interface capable of indicating when another user is online or otherwise available to accept messages.

Certain embodiments of the invention include methods and apparatuses for linking video information to electronic messages, such as electronic mail (email), online chat, web logs (“blogs”), bulletin boards, web page text, Short Message Service (SMS), Multimedia Messaging Service (MMS), and other electronic message formats.

In one example embodiment, the invention provides a method for linking video content to digital text messages, the method executed by a processor, the method comprising: initiating composition of a digital text message; receiving a signal from a user input device to select a digital video; playing the digital video; accepting one or more signals from a user input device to associate added text with a point in time of playback of the digital video; and inserting a link into the digital text message, wherein the link includes information to associate the added text with the point in time of playback of the digital video.

For clarity, various well-known components, such as power supplies, computer networking cards, processors, memory storage, Internet Service Providers (ISPs), firewalls, anti-hacking tools, and so on, have been omitted from the figures. In addition, various conventional controls, such as controls for closing interface screens, minimizing windows, and so on, are omitted. However, those skilled in the art with access to the present teachings will know which components and features to implement and how to implement them to meet the needs of a given application. Furthermore, the figures are not necessarily drawn to scale.

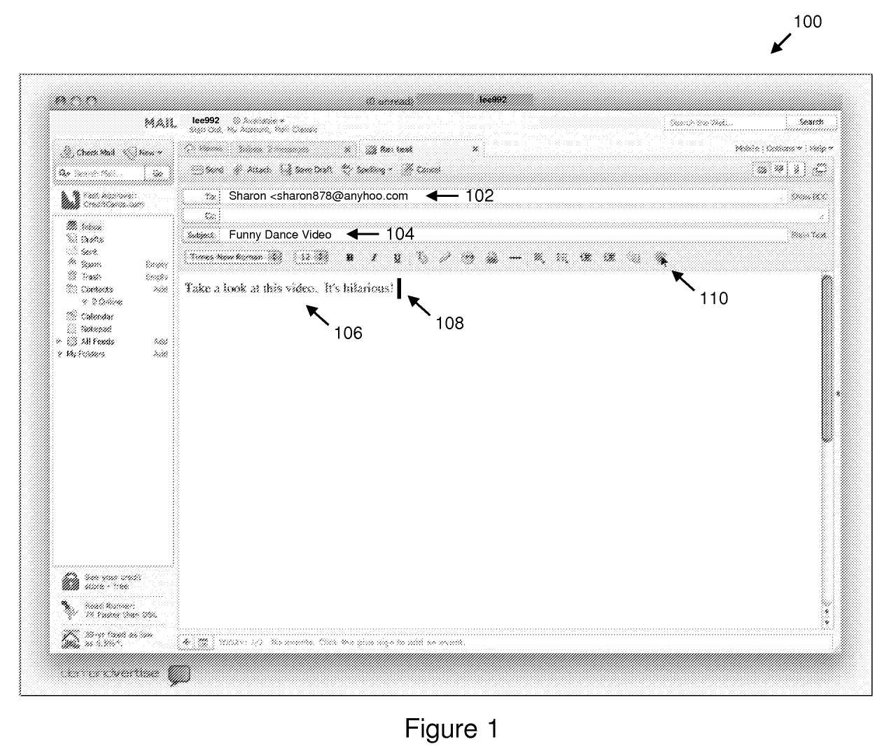

FIGS. 1-6 illustrate an example embodiment wherein video linking is provided for email and chat types of messaging.

In FIG. 1, email interface 100 includes a recipient's email address at 102. A title or subject line for the email is shown at 104 along with the email originator's comment at 106. The text for these fields can be entered in a traditional manner, or any other suitable manner. Additional email-related text, selections, fields, options or other email content and functionality may be provided and are not discussed in detail herein (i.e., in this document, the attached documents, and any other referenced information). For example, additional recipients may be added, a CC entry can be provided, an address book can be called up for use in addressing the email, priorities or security settings may be assigned to the email, etc.

A cursor is shown at the end of the message body at position 108. As is known in the art, a user typically types text on a computer keyboard and the text appears at the current cursor position. Other options for entering text can be used such as to copy text to a clipboard and paste the text using keystroke commands or hotkeys. The text is typically placed at the current cursor position. The cursor position can be changed by the user, as desired, such as by clicking at a position on the screen with a mouse and pointer.

In FIG. 1, a pointer is shown making a selection of a video link icon at position 110. Selecting the video link icon indicates that the user wishes to link to a video.

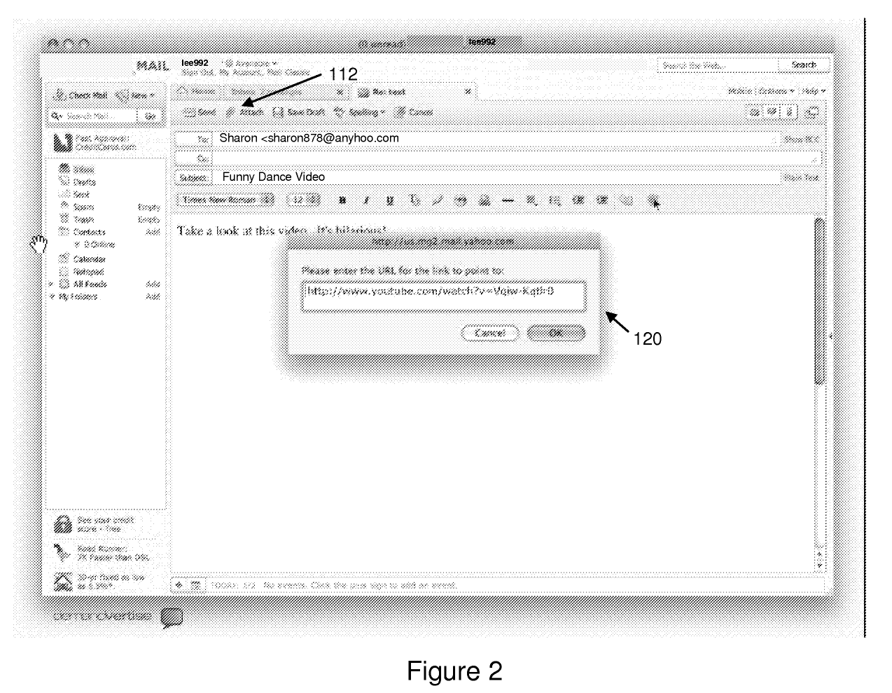

FIG. 2 shows a screenshot of the display just after the video link icon is selected. Dialog box 120 has appeared to allow the user to specify a location from which to obtain a video for playback and/or linking. In FIG. 2, a Uniform Resource Locator (URL) address has been entered by the user in order to identify a location of video content for linking. Other ways to identify video content for linking may be used. For example, a user can drag and drop a video icon into the email message. The video icon corresponds to a location of video content and the corresponding video content location is then associated with the email message. Yet another way to link video content may be to select an “attachment” option from an existing icon or menu selection in other options that are typically provided by email programs, such as by clicking on the paper clip icon labeled “Attach” at 112. Any other suitable mechanism can be used to indicate or associate video content for linking.

Once the user has indicated video content to be linked to the email message, a video annotation tool is displayed. In a preferred embodiment, the video annotation tool is similar to that described in Attachment 3, above. In general, any type of video annotation interface or tool may be used, where the annotation tool allows a user to associate text with a point in time of the video playback. A video annotation interface need not include all, or even the same, features described in the co-pending patents. It is not necessary that the user perform annotation at this point. For example, a video may have been previously annotated and the video can be selected (e.g., by dragging and dropping) into the email at the point shown in FIG. 1.

In the present example, it is assumed that a video annotation session takes place with a suitable interface and that a user has associated four different comments with different portions of the video. The user then ends the session by, e.g., clicking on a button to close the session, or performing some other act to indicate the annotation session is complete.

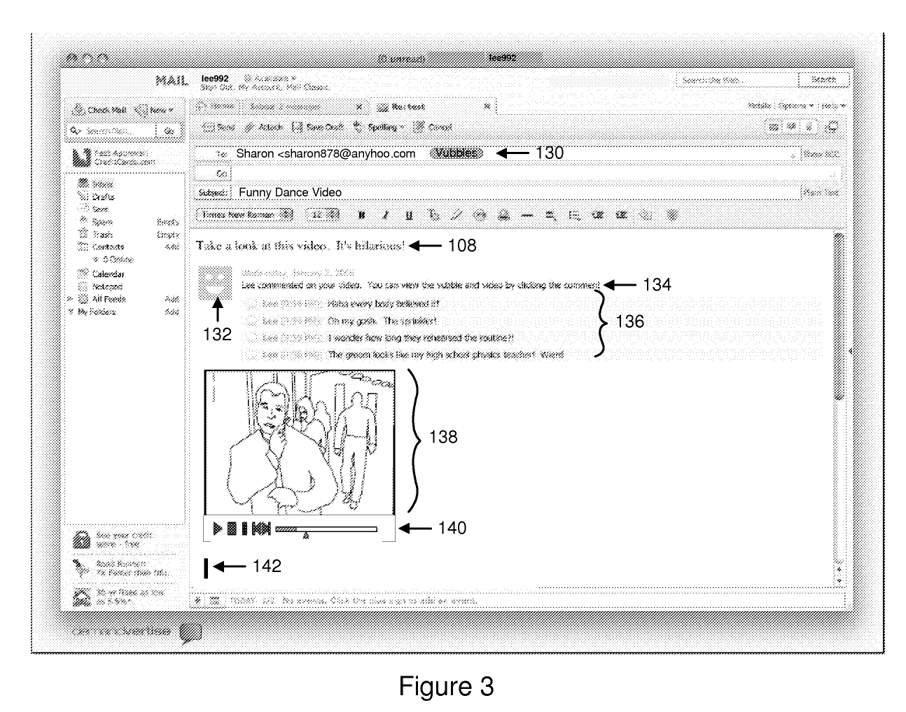

FIG. 3 shows the email display after the user has ended an annotation session. Video annotation access control icon 130 is placed adjacent to the recipient's email address. Clicking on this icon allows the originator of the email to assign rights and other properties as described in more detail, below. Various items corresponding to the video annotation session are included inline with the email message and inserted at the cursor position that was in effect when the video annotation session (or previously annotated video content) was invoked—namely, for this example, at position 108.

Items that are embedded into the message include set-off symbol 132, header text at 134, annotation text entries at 136, video window 138 and video transport controls 140. Note that other embodiments may omit or change these items unless otherwise noted. For example, set-off symbol 132 may be modified or omitted in other embodiments. The header information may be changed or omitted. Thumbnail images of the video can be used (as described below). The video window may be changed in shape or style or omitted in other embodiments. These variations to the number and type of video annotation session items that are embedded into the electronic message can be selectable by the message originator or author, set by an administrator, varied among different implementations as desired by the manufacturer or changed for other reasons, unless otherwise noted in the description herein, and particularly in the claims.

The annotation text entries at 136 show the author of each annotation (in this case the author is “Lee” for each annotation), the time at which the annotation was created, and the annotation content, or text. For example, the annotation “Haha every body believed it!” was created by Lee at 9:54 PM. The type of information that is included in the annotation text entries can vary. For example, it may be desirable to omit the author's name, or to omit the time of creation of the annotation. Rather than the time of creation of the annotation, the playback time at which the annotation appears in the video can be displayed. All or part of the text can be displayed. In other cases, an icon can be displayed in place of some or all of the text. In cases where an annotation is other than text (e.g., voice or other audio, or a graphic, video or other visual information, etc.) an icon or different mechanism for indicating the annotation can be used.

In FIG. 3, the cursor position has been updated to the end of the inline video annotation session items so that the cursor is now present at position 142. Should the user continue typing on the keyboard or perform another operation that enters text, the added text will appear at the new cursor position 142. The user/originator of the email message can use standard editing techniques to add text before, after, or in-between the items. Or the user may delete or move the items as the items may be treated as text, hypertext, Hyper-Text Markup Language (HTML), digital images (e.g., GIF, JPEG, TIFF or other suitable formats) or any other format or type of object that can typically be inserted into an electronic message.

In other embodiments the insertion of video annotation session items need not be so closely tied to the cursor position. For example, the items may be automatically placed at the end or beginning of the electronic message. Or a separate window or attachment can be generated that includes the items. The items can be associated with the electronic message by a hyperlink, attached to the message, or by other means.

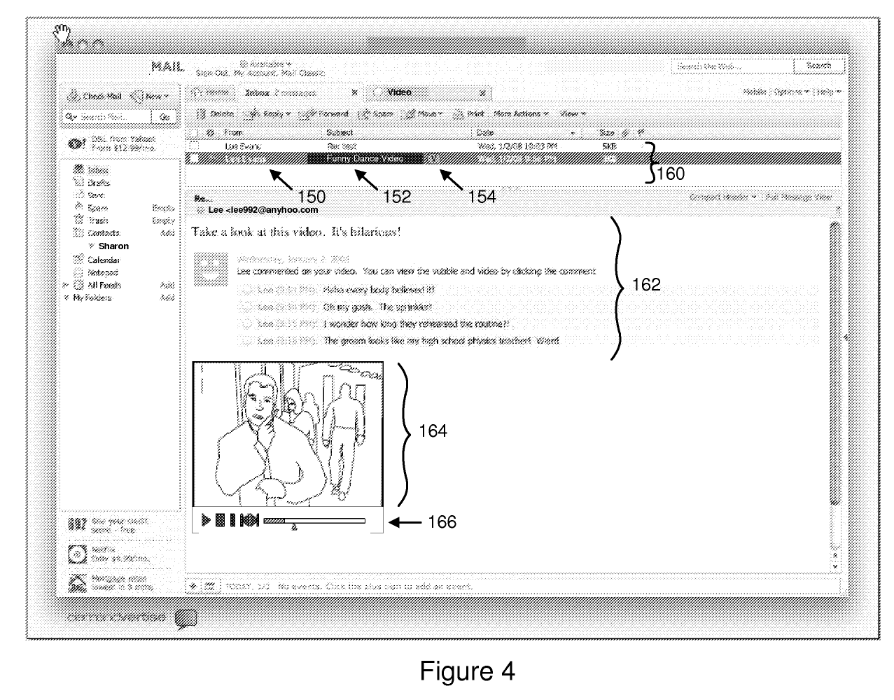

FIG. 4 illustrates an email message including video links as it can appear in a recipient's in-box in an email interface. In FIG. 4, the recipient's email in-box is shown at 160. The in-box includes indications of two messages, with each message indicator included on a row or line. The lower row shows an entry for an email with video linking. The lower row includes the name of the sender of the corresponding email 150, subject or title of the email as “Funny Dance Video” at 152, and video link icon 154. In a preferred embodiment the video link icon is used in association with an email message or header to show that the email message includes information related to a video clip. The video link icon can be activated (e.g., by a mouse click or other user input signal) to open other options or controls. The options or controls can allow an email author, recipient or other user or viewer to set additional parameters or values, or invoke functions associated with video annotation and/or electronic messaging as described in the documents provided with this application, or as known in the art or developed in the future.

For example, mousing over the video link icon can cause a pop-up window to appear that lists video annotations that are present in the message. Other information can be shown such as the author's of the annotations, time of annotation, etc. Clicking on the video link icon can cause a video playback or video annotation interface, or portions thereof, to appear. Video that is the subject of the message can be played back in the player or annotation interface according to the description of relevant features herein.

The video link icon (or merely “video icon”) can represent a field or attribute associated with the email similar to other email attributes (e.g., sender, subject or title, time of receipt, priority, etc.) that can be searched, filtered, or otherwise processed in ways known in the art or future-developed to help allow a user to organize, manage or control their email. The video icon can assume different on-screen positioning, colors, shapes, animations, or other characteristics in order to indicate information that may be of-interest to a user. For example, if the originator/sender or any recipient copied on the email is currently annotating or viewing a video that is the subject of the email then the video icon can change in color or can have an animation. Such an indication could alert the recipient that a real-time chat may be entered (as described in other parts of this application) or that the recipient may want to review the video and/or message correspondence in anticipation of a related communication from one of the other users in the group.

Other functions and features may be associated with the video link icon, as desired. For example, operation of the features described in the Attachments can be selectively and variously provided based on a video icon associated with the email or other electronic message. The video icon can be on, within adjacent to or otherwise associated with any of several aspects of electronic messaging such as with a header, message, folder, application launch icon, user profile, web page, blog, chat, etc. The video icon may be a separate or standalone icon that can appear in a task bar, desktop, folder, clipboard or other aspect of a computer operating system or digital user interface. For example, the video icon may be an icon on a display of a cell phone or portable computing device.

FIG. 4 shows the email message discussed above opened into area 162. The email message appears substantially as it was authored. Video window 164 and video transport controls 166 are also included. Other embodiments need not include all or the same components or message parts that were present when the message was sent. For example, a sender may select viewing rights per recipient that prevent some recipients from seeing the video content. Or a recipient may desire to filter video content from their messages. The annotation text entries are included in the message body followed by the video window and transport controls. The user may select “reply” to the email message within the email system and then click on the annotations to launch a video viewer or video annotation tool to add their own annotations to the email thread. The annotations can appear at the current cursor position when the annotation session is ended and can be manipulated by the user (e.g., cut, pasted, highlighted, change of font, etc.), as desired. In other embodiments, the style, selection and arrangement of components in messages may vary from those disclosed herein.

An example method suitable for use with the interface of FIG. 4 includes initiating an email session; associating video content with the email session; accepting a signal from a user input device to transition to a chat session; entering a chat session in response to the signal; and automatically displaying a reference to the video content within the chat session.

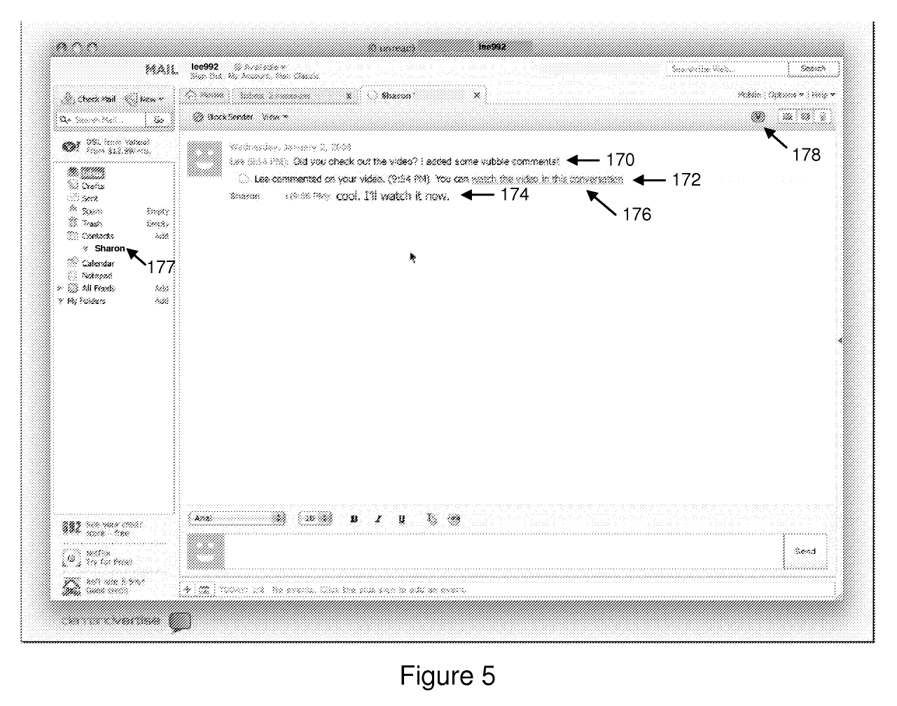

FIG. 5 illustrates a chat messaging session including video linking. The interface illustrated in FIG. 5 can be entered, for example, from a control on a prior interface such as a button (not shown) in the interface of FIG. 4. This allows a user to transition easily from an email mode to a chat mode as is known in the art. For example, if a user is viewing an email with video linking and an indicator such as 177 of FIG. 5 shows that the sender of the email (or another person in the user's contact list) is currently online then the user may click a control to try to initiate a chat session with the online person. Thus, the screen shown in FIG. 5, is after the originator/sender, Lee, has initiated a chat session with Sharon. In a preferred embodiment, the act of initiating a chat session when an email including a video is open transitions to chat while automatically associating the video with the chat session. Other approaches are possible including allowing the user to enter a chat session with a selected video (e.g., by browsing to select a local video clip, cutting and pasting a link, etc.). Video can also be associated during a chat session. In a preferred embodiment, video button 178 is provided to initiate insertion of a new video clip during a chat session.

Once video is associated with a chat session a link is provided within the chat session to provide a video player and/or annotation tool as described herein for email messaging. FIG. 5 shows a chat session after a transition from email to chat. The chat session is initiated by Lee with a chat invite to Sharon who has accepted. In the chat session Lee's posted messages appear in substantially real time. For example, Lee's statement at 170 is shown on Sharon's chat panel shortly after Lee hits the ENTER key or other control to signify that the statement is completed. Similar to the email application, when a video annotation session is completed a link to the video and annotations, if any, is treated as a complete chat statement and is displayed in the chat participants' chat panels.

Another approach is to provide an indication of each annotation in the chat panel when the annotation is completed rather than when the session completes. A similar approach can be adopted for email or other messaging formats, if desired. A statement that relates to a video link or annotation is automatically generated by the chat system and an example of such a statement appears at 172 of FIG. 5. The video link statement includes a link at 176 to launch a video player and/or annotation tool that can be invoked by any participant in the chat session since it can appear on all participants' screens. The link need not be used and chat can proceed normally with or without additional intervening video viewing or linking. For example, FIG. 5 shows Sharon's response to Lee's initial chat statement and video link statement.

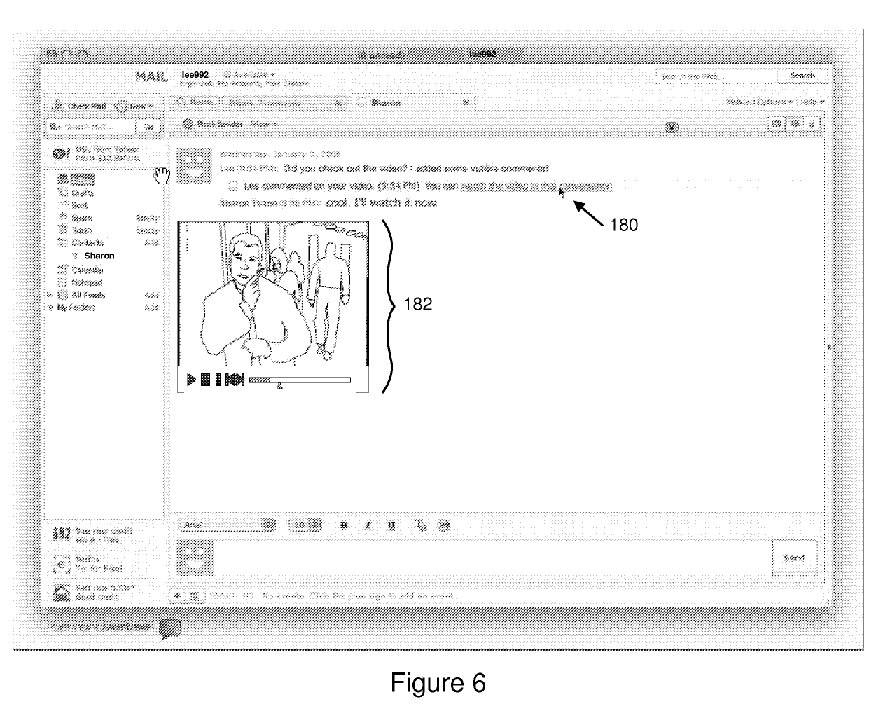

FIG. 6 illustrates the chat panel after the user has clicked on the embedded video link “watch the video in this conversation” at 180. The video link may be any suitable indication that video is available for viewing and/or annotation. As a result of selecting the video link, the video and associated controls appear at 182. The video player and/or video annotation tool may be any suitable tool as described herein or as known or provided by other technology or third parties, including future-developed players/tools.

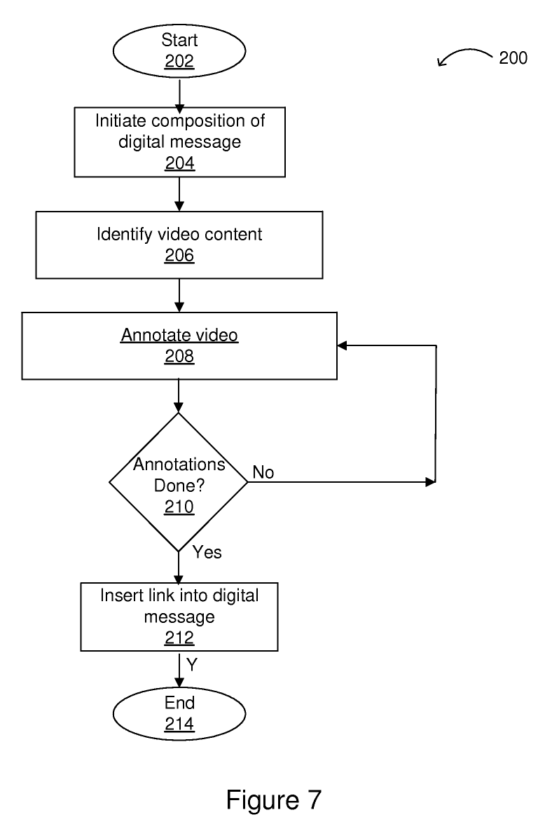

FIG. 7 illustrates a flowchart showing basic acts by which functionality described herein may be provided. The flowchart is but one example of a way to implement the functionality and it will be apparent that many other approaches are possible.

The routine represented by flowchart 200 of FIG. 7 is entered at 202 when it is desired to provide an annotated video associated with an electronic message. At step 204 composition of a digital message is initiated. This can be by, for example, launching an email or chat application, word processor, html or other editor, voice-to-text translation utility, etc. Next, step 206 is performed to identify video content. The identification can be by a user using a user input device to provide a signal to a device or processor executing software. Another possibility is to provide automated or semi-automated identification of video content. For example, if it is known that video content is already being discussed or has been otherwise identified (such as where the video has appeared earlier in an email thread) then the identification of the video can be performed automatically by a search of the video thread, or by detecting an identifier associated with the email thread, wherein the identifier relates to a video. Semi-automated identification can include a user typing in a search term that is used by a search engine to select a video. Other specific identification methods are possible.

Once a video is identified, steps 208 and 210 are executed to allow user annotation of the video. Annotation proceeds until the user indicates that the session is over at which point execution of step 212 occurs. Note that other embodiments need not require an annotation session to end before proceeding. As described above, each separate annotation statement can cause a link or other indicator to be placed in the text which may be desirable in a chat application. Yet another application can allow each word or character of an annotation to be placed within, and appear upon displaying, a part of a message to which the video and annotations are being associated.

At step 212 a link is inserted into the digital message. In a preferred embodiment, link insertion occurs at a current cursor position. However, other placements of the link are possible, as desired and as described, above.

Functionality and actions described in the flowchart of FIG. 7, and elsewhere in this application, can be implemented by any suitable means including hardware, software or a combination of both. The functionality may be concentrated in one device, process or geographical area or it may be distributed among multiple devices and/or processes. For example, the system designs described in Attachment 3 can be used as the basis for a suitable implementation of the functionality.

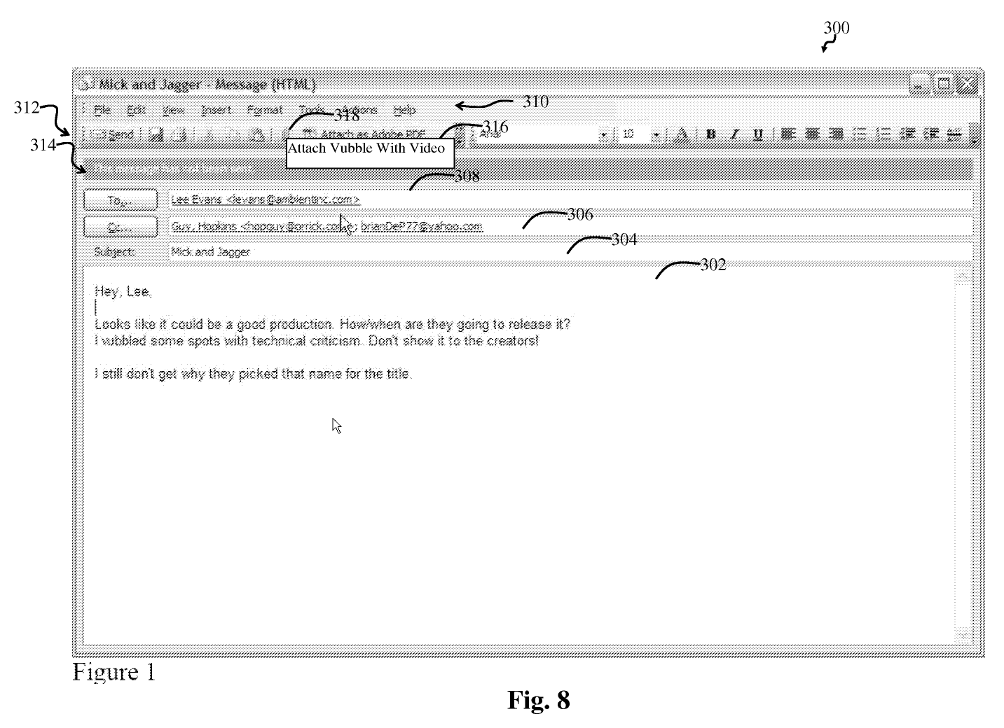

FIG. 8 shows a seventh user interface screen 300 according to a third example embodiment. The seventh user interface screen 300 includes various fields and controls, including a message field 302, a subject field 304, a Carbon Copy (CC) field 306, a to field 308, a menu bar 310, messaging tool bars 312, and a message status bar 314.

The interface 300 facilitates composing an email message and includes, but is not limited to, functionality often associated with existing email interfaces. For example, the seventh user interface 300 allows a user to have full power of an underlying email system's address book, addressing functionality (e.g., CC, BCC), sending functionality (e.g., delayed send, sent-items tracking), group lists, date stamping, searching, filtering, and other features and controls. Such functionality may be accessed, for example, via the menu bar 310, tool bars 312, and so on.

However, the interface 300 includes additional functionality, including an attach-video-with-vubble button 316 in the toolbars 312. The attach-video-with-vubble button 316 enables a user to attach or include video content and associated vubbles in the body of the email message 302. For the purposes of the present discussion, a vubble is said to be included in an electronic message, such as an email message if content of a vubble is viewable directly in or from an electronic message, such as via a hyperlink. Hence, vubble content may be embedded directly in a message; a hyperlink may be provided to vubble content; or a link may be provided to software or functionality that may access or retrieve vubble content.

Note that the attach-video-with-vubble button 316 may be omitted without departing from the scope of the present teachings. In an embodiment where the attach-video-with-vubble button 316 is omitted, a user may select another option, such as the paper clip button 318 to facilitate attaching a video with vubble content associated therewith.

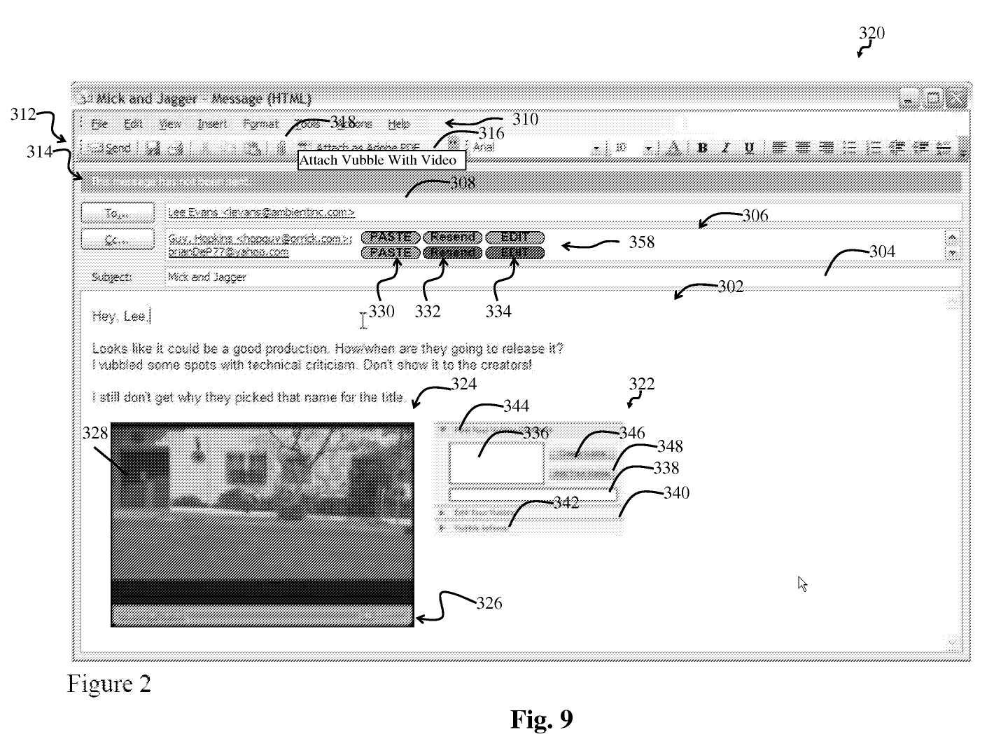

FIG. 9 shows an eighth user interface screen 320, which includes a vubble interface 322 for use with the third example embodiment.

In the present embodiment, the vubble interface 322 is displayed adjacent to a video player 324, which includes transport controls 326. The transport controls 326 enable a user to jump to different portions of a video to establish start and end points for insertion of a vubble via the vubble interface 322. For illustrative purposes, the video player 324 is shown illustrating a frame of a video. Hence, the vubble controls 322 in combination with the video player 324 and accompanying transport controls 326 of the interface screen 320 facilitate user navigation within the digital video 328 and further facilitate accepting signals from a user input device to define the added text at a point in time of playback of the digital video, e.g., via the vubble interface 322.

As shown by the interface screen 320, the user has inserted the video player 324 and accompanying video (represented by the video frame 328) and has activated the vubble interface 322 by inserting a video clip into the message field 302. Insertion of a video clip may occur via an insert menu of the menu bar 310, the paper clip button 318, the attach-video-with vubble button 316, by dragging and dropping an icon associated with a video clip into the message field 302, or via another mechanism or method. Insertion of a video in a message via the present example interface 320 further activates display of additional vubble-rights controls 358.

The video player 324 and the vubble interface 322 of FIG. 9 were inserted after a cursor location in the message field 302. Note that other techniques may be employed to position or move the video player 324 and vubble interface 322 within the message field 302.

The video content represented by the video frame 328 may be embedded within the message 302. Alternatively, the video content may be streamed from a server to the player 324 as needed, in which case, the video content is said to be linked video content.

In the present embodiment, the vubble interface 322 has been automatically embedded in the message field 302. Alternatively, an intervening dialog box could be used to provide a user option to display or not to display the vubble interface 322. Furthermore, the vubble interface 322 may be closed as desired, such as by right-clicking the vubble interface 322 and selecting a close-vubble option in a resulting drop-down menu (not shown).

The additional vubble-rights controls 358 are shown in the CC field 306. The vubble-rights controls 358 include a paste buttons 330, resend buttons 332, and edit buttons 334 for each recipient. Each of the buttons 330-334 represents rights, wherein the color of the particular button indicates whether the associated recipient has rights to employ the associated functionality, e.g., paste, resend, edit, and so on. Buttons associated with restricted rights are shown whited out. However, other color-coding may be used.

When additional vubbles are added to video content, the vubbles are said to be pasted into the video content. If the paste buttons 330 are not whited out, the corresponding recipients are allowed to paste vubbles, otherwise, they are not allowed to paste vubbles. Similarly, if the resend buttons 332 are not whited out, then the corresponding recipients are allowed to resend the video content represented by the video frame 328, such as by resending a video link associated therewith. Similarly, if the edit buttons 334 are not whited out, then corresponding recipients are allowed to delete vubbles from the video content otherwise edit vubbles therein, such as vubbles that were previously added by the sender and/or the recipient. For example, brianDeP77@yahoo.com is not allowed to resend the video content or to resend or edit content created via the vubble interface 322, but he can add additional vubbles to the video content represented by the frame 328.

The user, i.e., sender in the interface 320 of FIG. 9, may selectively click on buttons of the vubble-rights controls 328 to toggle rights on or off. While in the present embodiment, vubble-rights controls 328 are displayed in the CC field 326, note that related controls may be displayed elsewhere. For example, a menu accessible via the vubble interface 322 may facilitate specification of vubble rights for a particular recipient of an electronic message. Other features for access rights, security, and so on, can be provided via the vubble interface 322.

The vubble interface 322 represents a set of vubble controls. For the purposes of the present discussion, a vubble control may be any user interface component linked to functionality that is adapted to facilitate modifying a vubble, affecting vubble behavior, such as how, when or where the vubble is displayed, and so on.

A user may use the vubble interface 322 to paste, i.e., insert or associate vubbles with particular portions of the video content 328. Vubble insertion into a video or in association with a video is discussed more fully in the co-pending U.S. patent application referenced above, entitled “USER INTERFACE FOR CREATING TAGS SYNCHRONIZED WITH A VIDEO PLAYBACK” which is incorporated by reference herein. Various interface functionality provided in the above-identified U.S. patent application may be incorporated into the vubble interface 322.

In the present embodiment, the vubble interface 322 includes a vubble-text field 336 for accepting text for the creation of a vubble, and a vubble-hyperlink field 338 for accepting a hyperlink to be inserted in the vubble. A created vubble may be pasted at start and end positions in the video 328 as established via the transport controls 326. The vubble interface 322 includes additional vubble controls, which may be accessed via a vubble-edit drop-down menu 340 and a vubble-action drop-down menu 342. A vubble-posting drop-down menu 344 may be accessed, for example, by clicking on the associated header to expose the vubble fields 336, 338. The first drop-down menu 344 further includes a create-vubble button 346 and an add-vubble button 348. When activated, the create-vubble button 346 enables access to additional vubble-creation controls. The add-vubble button 346 triggers insertion of the associated vubble, including content specified in the vubble fields 336, 338, into a selected portion of the video 328.

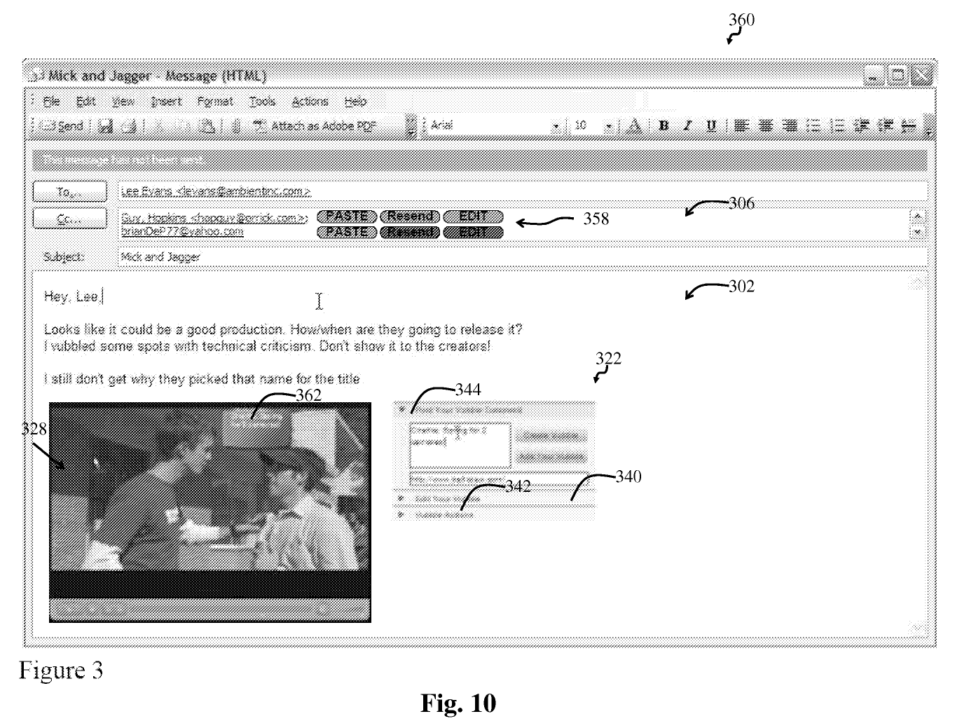

FIG. 10 shows a ninth user interface screen 360 illustrating vubble paste, i.e., insert functionality for use with the third example embodiment. The interface screen 360 is substantially similar to the interface screen 320 of FIG. 9 with the exception that a user has entered text in the vubble-text field 336; has entered a hyperlink in the vubble-hyperlink field 338; and has pasted a corresponding vubble 262 into the video 338.

The vubble interface 322 provides access to controls, such as via the drop-down menus 340-344 to assign different vubble fill colors, text colors, text fonts, styles, and so on. The vubble interface 322 further provides access to functionality that enables a user to make multiple vubble designs, e.g., with different colors, text styles, and so on. Accordingly, vubbles with different styles, colors, and so on, may be pasted at different positions in the video 328, thereby enabling the user to annotate the video 328 such that, for example, different characters talking in the video 328 may be associated with a different vubble style. The resulting video is said to exhibit cartoon-strip characteristics.

Furthermore, different animations, graphics, vubble transitions, vubble durations, and other features can be selected via control provided in one or more of the drop-down menus 340-344. In addition, a video display duration can be selected, such that only a desired portion of a given video is displayed. Furthermore, a video playback speed may be set to cause a given video to playback faster or slower at different portions of the video 328.

Various vubble features and qualities may be independent of a given email thread, i.e., set of exchanged corresponding email messages. A given email thread may be handled in a traditional manner (e.g., each participant may delete an email containing vubbles at will). However, the ability to play a given video that has been annotated with vubbles (called a vubbled video) may be handled separately, such as in accordance with the sender's defined rights.

The sender of an email message with a vubbled video acts as the administrator and has control over rights assignments, vubble authoring features, and vubble display if any. For example, the sender may prevent certain recipients from viewing a vubbled video by setting access rights accordingly via one or more controls accessible via the vubble interface 322 or via the vubble-rights controls 358 in the CC field 306. The vubble interface 322 also enables the sender of a vubbled video to cancel or otherwise control the availability of a given vubbled video after a predetermined time (video lifetime). The sender may also edit received vubbles to the extent that the sender has been granted appropriate access rights by the original sender of the vubbled video. In addition, a user may place advertisements, monitor user comments, monitor vubble behavior, and so on. In general, the vubble interface 322 enables a user to access similar features as those described in various embodiments of the above-identified co-pending U.S. patent application whether or not the vubbled video 328 is hosted on a separate server and accessible via a particular website.

In the present embodiment, one or more routines for implementing the vubble interface 322 may reside on a remote server that is separate from the server used to send and receive the associated email message 302.

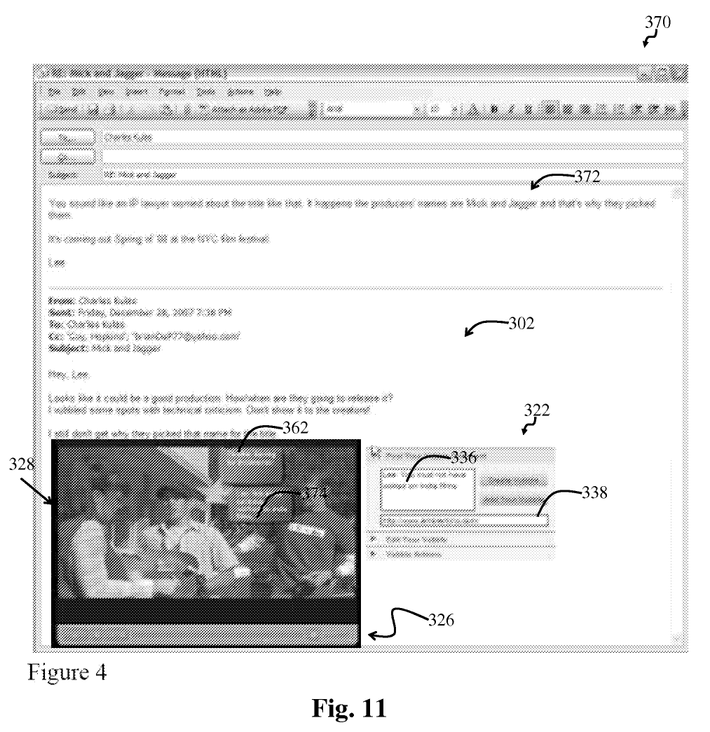

FIG. 11 shows a tenth user interface screen 370 after a recipient (Lee) has received the electronic message 302 shown in the third interface of FIG. 10. As shown in FIG. 11, the recipient (Lee) is responding via a reply message 372. Lee is considered the sender of the reply message 372 and the recipient of the previously sent message 302.

The received email message 302 appears in each recipient's inbox and may be listed as a standard email. Alternatively, an icon or other indication may be displayed in a recipient's inbox indicating that a video or vubbled video is attached.

The interface screen 370 further shows the recipient (Lee) using the vubble interface 322 to add, i.e., paste, a reply vubble at a particular point in the video playback 328. The recipient (Lee) has entered text for the creation and insertion of a new vubble 374 in the vubble-text field 336 and has entered an additional hyperlink via the vubble-hyperlink field 338 to be included in the new vubble 374.

The video represented by the frame 328 may behave according to any features that have been contemplated in other applications, including the above-identified U.S. patent application. For example, the reply vubble 374 may be displayed in-frame at designated starting (“in”) and end (“out”) points in the video playback. The in and out points for display of the vubble 374 may be established via the transport controls 326, such as by using the controls to navigate to a start position to create the vubble 374 and then navigating to an end position to paste the vubble via the add-vubble button 348.

In the present embodiment, when the recipient (Lee) opens the received email message 302, the recipient sees the first frame of the video represented by the frame 328. The recipient can then play the video 328 via the transport controls 326 to view vubbles added to the video 328 by the original sender (Charles Kulas). The recipient can optionally paste additional vubbles via the vubble-interface 322, as shown by the example interface screen 370 of FIG. 11.

The recipient (Lee) can also use any standard email controls to handle a reply email message. For example, “Reply” or “Reply to All” can be selected; additional recipients can be added or the email message can be forwarded, assuming the creator has awarded forwarding rights, and so on

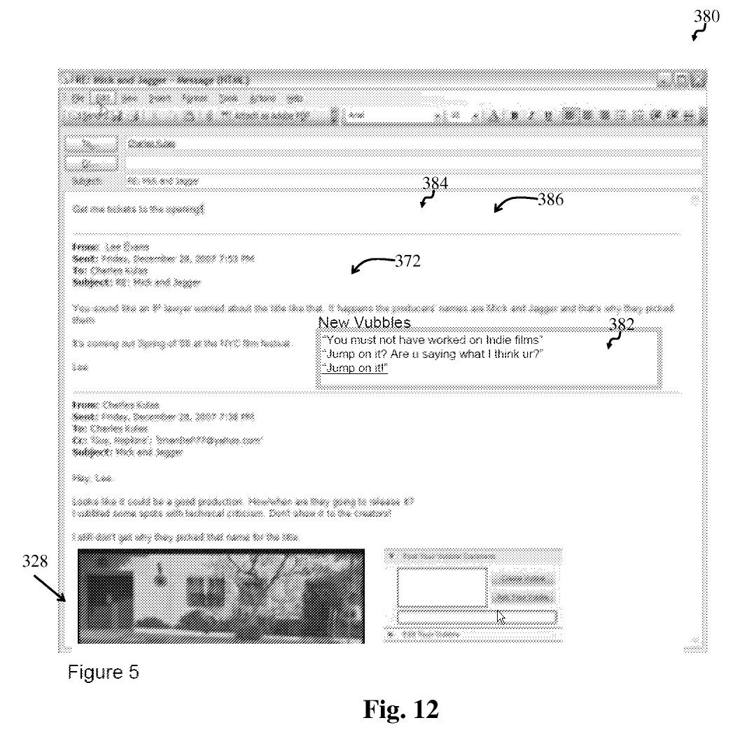

FIG. 12 shows a eleventh user interface screen 380 with a vubble-indicator index 382 after the original sender (Charles Kulas) receives the reply message 372 shown in FIG. 11. The new recipient (Charles Kulas) is entering a new reply message 384 and is considered the sender thereof.

The vubble-indicator index 382 represents a list, wherein elements in the list identify vubbles added to the video 328 by the sender of the previous email message 372. Use of the vubble-indicator index 382 facilitates organization and indicates which participants in an email thread have added which vubbles to the originally sent vubbled video 328.

In summary, some of all of the text for the new vubbles that the sender (Lee) has added to the video 328 appears in the vubble-indicator index 382. In the present embodiment, this vubble-text is embedded in Lee's email 372 in the vubble-indicator index 382.

The vubble-indicator index 382 enables a recipient (e.g., Charles Kulas) to click on the corresponding vubble text, which jumps the focus of the email reader to the video playback 328 shown at the bottom of the eleventh user interface screen 380. The video transport also jumps to a point in the video playback 328 at or near the appearance of the corresponding new vubble.

In this manner, the user (Charles Kulas) can choose to view the video 328 anew (e.g., by scrolling down to the video display 328 and re-playing the video via transport controls. This causes previously added and newly added vubbles (which were not deleted or otherwise rights-restricted) to appear at their appropriate points. The user may also choose to jump to see new vubbles in the video playback 328 by clicking on the corresponding text for the new vubbles displayed in the vubble-indicator index 382. The user may also decide not to view the vubbles in the video playback 328. In general, each user can post new text by adding to the email thread in a traditional manner and/or by pasting vubble text or other vubble content using the vubble interface 322 and video transport controls 326 shown in FIG. 11.

If the recipient (Charles Kulas), who has now become the sender of the reply message 386, adds new vubbles to the video playback 328 when creating the reply message 386, the recipient (Lee) will also see a corresponding vubble-indicator index similar to the index 382 shown in FIG. 12. A corresponding vubble-indicator index may appear for other participants in a given email thread.

Additional controls, displays, and information can be provided for vubble viewing, creation, handling, and so on. For example, a vubble can be made into a hyperlink so that clicking on the vubble opens a web page with the content from a website or otherwise associated with a given Uniform Resource Locator (URL). Furthermore, text within a vubble can be hyperlinked so that each phrase, word, letter, symbol, and so on, may have a different link. In the interface screen 380 of FIG. 12, vubble text that corresponds to a vubble, or text with a hyperlink is underlined in the vubble-indicator index 382.

Other features include the ability to display a “comic strip” version of a vubbled video so that each time a vubble has been pasted, a frame of the video 328 is captured an laid out in a comic-strip or slideshow fashion. There need not be a separate strip frame associated with each new instance of vubble pasting. Two or more vubble pastes that occur within close time of each other can have their in points (i.e., start points) combined so that only a single frame is used to represent the appearance of two or more vubbles in the comic-strip or slideshow layout. Such comic strip or slideshow functionality may be accessed via one or more controls accessible, for example, via the vubble-action button 342.

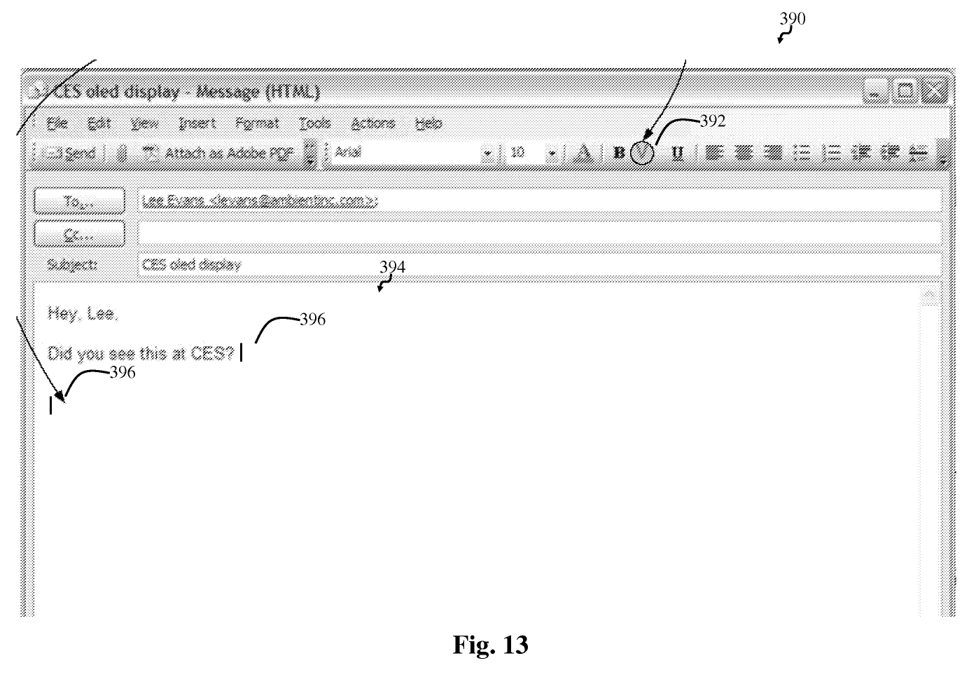

FIG. 13 shows a twelfth user interface screen 390 with a vubble-insert icon 392 according to a fourth embodiment. As shown in the user interface screen 390, a user (Lee) has entered an email message 394 and has positioned a cursor 396 at a desired position in preparation for insertion of a vubbled video, i.e., video to be annotated with one or more vubbles, at the cursor location. To insert a video with annotated vubbles at the cursor location 396, the user positions the cursor 396 as desired and the selects the vubble-insertion icon 392.

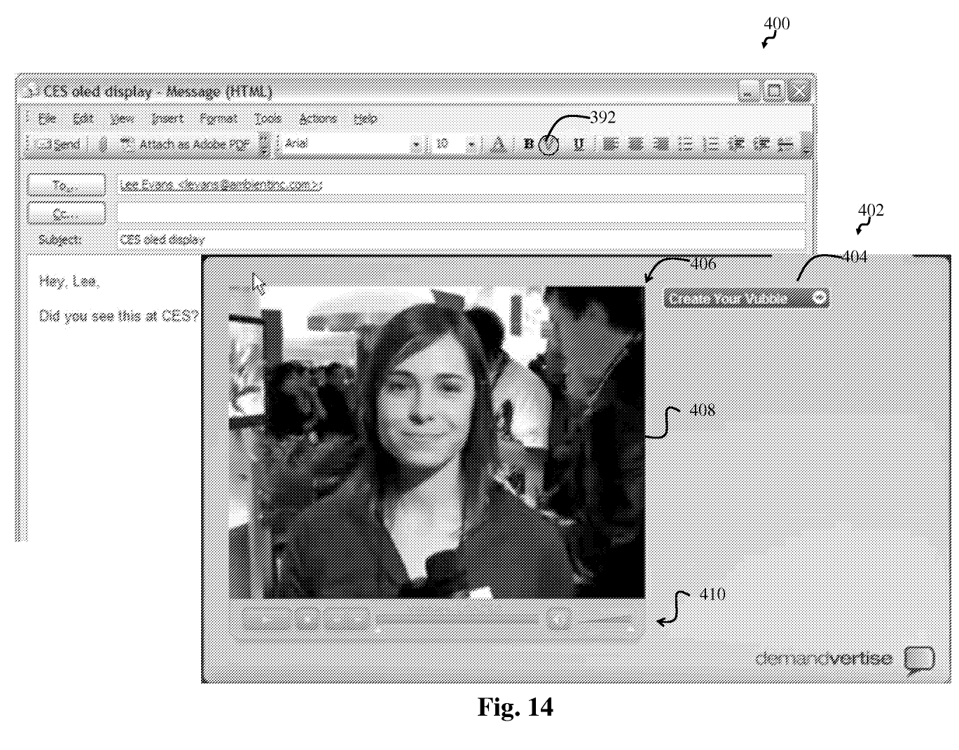

FIG. 14 shows a thirteenth user interface screen 400 illustrating a vubble-authoring tool 402 activated via the vubble-insert icon 392 of FIG. 13. The vubble-authoring tool 402 includes a create-vubble control 404 adjacent to a video player interface 406. The video player interface 406 includes a video display 408 and transport controls 410. The vubble-authoring tool 402 may appear at the cursor location shown in the email message 394 of FIG. 13 or may appear elsewhere in or about the interface screen 400.

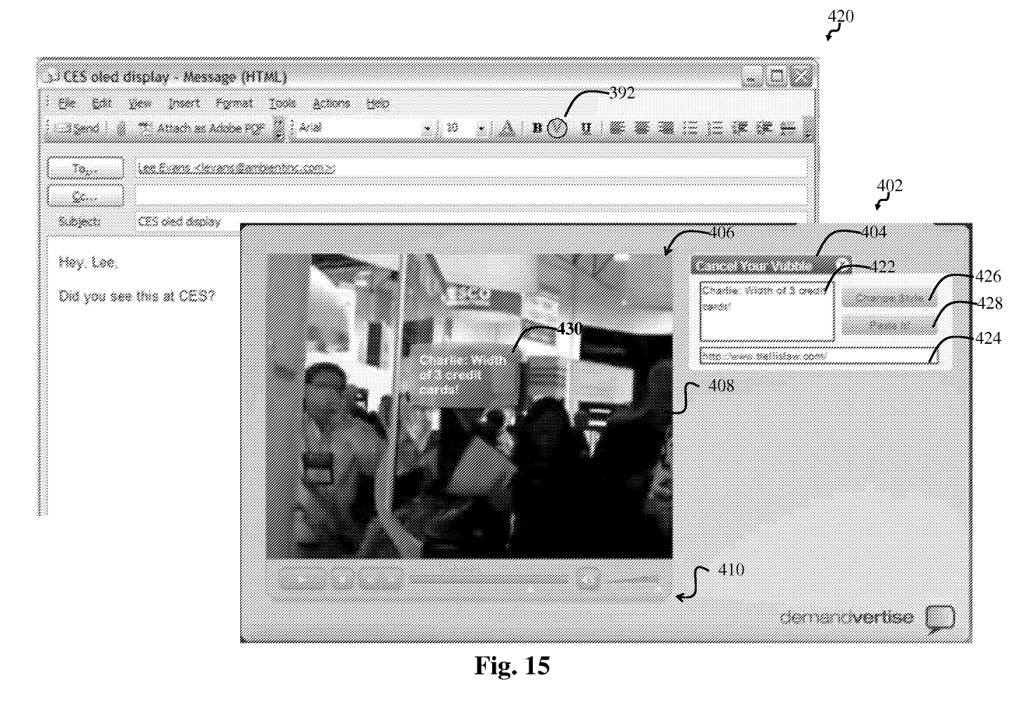

FIG. 15 shows a fourteenth user interface screen 420 illustrating the vubble-authoring tool of FIG. 14 after a user has selected the create-vubble control 404 thereof. As shown in the interface screen 420 of FIG. 15, the user (sender) has selected the create-vubble control 404, which has activated a vubble-text field 422 in which vubble-text is added. Selection of the create-vubble control 404 has also activated a hyperlink field 424, in which a vubble-hyperlink is added, and a change-style button 426, and a past-vubble button 428.

Selection of the change-style button 426 activates additional controls to enable the user to change the appearance of the vubble being created. Selection of the paste-vubble button 428 inserts the resulting vubble 430 into the video display 408 at a selected position in the video display 408 and at the desired frame to which the user has navigated.

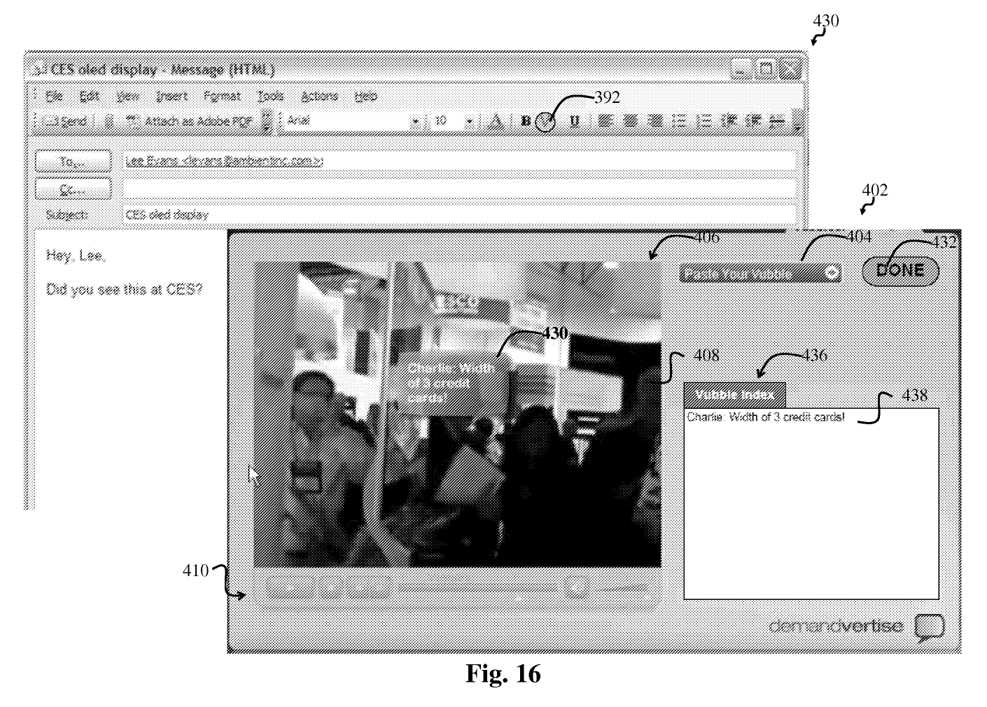

FIG. 16 shows a fifteenth user interface screen 430 illustrating the vubble-authoring tool 402 of FIG. 15 after a user has inserted, i.e., pasted, the created vubble 430 into the video display area 408. After vubble pasting, a done button 432 is displayed in the vubble-authoring tool 402. In addition, a vubble index 436 appears identifying some or all of the text associated with any vubbles 430 inserted into the video display area 408. From the user interface screen 430, the user can end the vubble-creation session or may continue to create and paste additional vubbles.

The vubble index 436 enables users to jump to a position in the video display 408 corresponding to the start position of the associated vubble by clicking on the text, i.e., vubble indicia 438, associated with the vubble as displayed in the vubble index 436. The user may then further edit the vubble or perform other desired functions. When a new vubble is added to the video display 408, corresponding new linked vubble indicia is displayed via the vubble index 436.

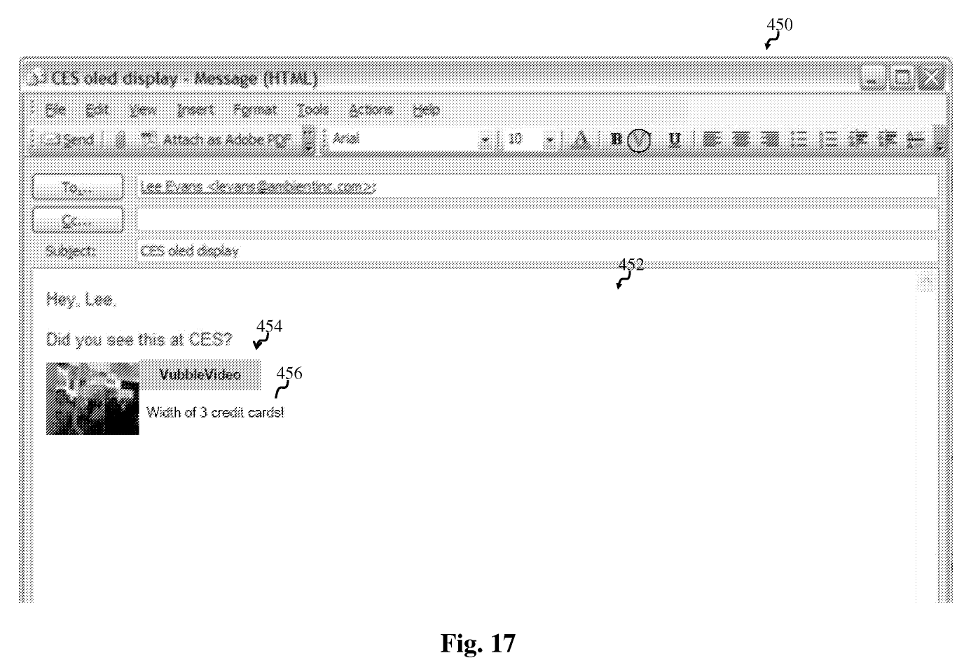

FIG. 17 shows a sixteenth user interface screen 450 illustrating an electronic message 452 incorporating or referencing a vubbled video 454 ready to be sent to a recipient according to the fourth embodiment. The interface screen 450 appears after the user (sender) has selected the done button 432 in the interface screen 430 of FIG. 16. An icon representing the vubbled video 454 is displayed along with a listing 456 identifying vubbles incorporated in the corresponding vubbled video. The vubbled-video icon 454 appears at the original position of the cursor 396 selected in the interface screen 390 of FIG. 13.

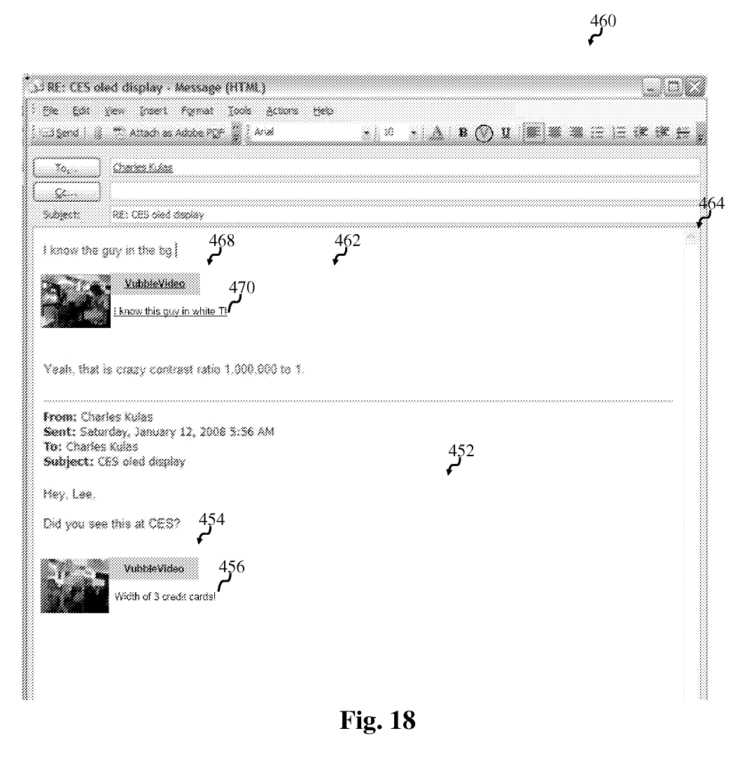

FIG. 18 shows a seventeenth user interface screen 460 illustrating an email thread 464, i.e., sequence of messages, incorporating the vubbled-video icon 454 of FIG. 17 and a reply message 462 newly created by a recipient of the electronic message 452 of FIG. 17. The recipient of the message 452 is now the sender of the new reply message 462. The reply message 462 is shown including a new linked vubbled-video icon 468 along with vubble indicia 470 indicating any new vubbles added by the sender of the reply message 462.

As shown in the seventeenth user interface screen 460, the recipient of the original message 452 has clicked on the original vubbled video icon 454, also called a vubblevideo link, to view the video and the first vubble created by Charles Kulas and provided via the original message 452. The recipient (Lee) has pasted a new vubble, which is indicated by the vubble indicia 470 in the reply message 462. A link to the associated vubbled video is graphically depicted via the new linked vubbled-video icon 468 in the reply message 462. The resulting sending of the message 462 back to Charles Kulas may be handled normally as is known in the art for electronic transfer of email messages.

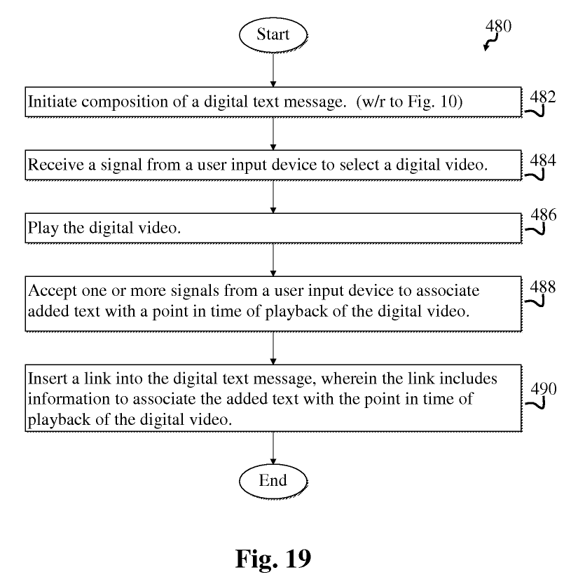

FIG. 19 illustrates a flowchart of a second routine 480 adapted for use with the embodiments of FIGS. 8-19. The routine 480 is adapted to be implemented via a computer-readable storage medium capable of executing instructions via a processor and capable of linking video content to digital electronic messages.

The routine 480 includes instructions corresponding to a first step 482, which includes

The routine 480 includes a first step 482, which includes initiating composition of a digital electronic message, such as a text message.

A second step includes receiving a signal from a user input device to select a digital video. The signal may include a hyperlink to a desired video; may result from dragging and dropping an icon representing the desired video into a message area, and so on.

A third optional step 486 includes playing the indicated video.

A fourth step 488 includes accepting one or more signals from a user input device to associate added text with a point in time of playback of the digital video. This association may occur, for example, via transport controls included in a video player used to play the video.

A fifth step 490 includes inserting a link into the digital electronic message, wherein the link includes information to associate added text with the point in time of playback of the digital video.

Various features from different embodiments may be used with features from other embodiments. For example, features of certain embodiments of FIGS. 1-18 may be combined or interchanged with features of other embodiments.

Although the invention has been described with respect to specific embodiments thereof, it should be apparent that variations of these embodiments are possible and may be within the scope of the invention. For example, although specific types of digital messaging, such as text, have been described, it may be possible to adapt functionality described herein to other forms of communication including voice or visual communication. Although the chat messaging application has been described as part of an integrated session where video content is associated with chat after first being associated with email, other embodiments may use functionality described herein to transfer associated video from chat to email, or to provide functionality in standalone email or chat programs where no session transfer need occur.

Hence, although embodiments of the invention are discussed primarily with respect to vubble authoring and incorporation of vubbled videos in electronic communications sessions, such as email communications or chat sessions, any type of electronic messaging system and playback system can be used to implement features described herein and may be adapted for use with embodiments of the present invention. For example, animations, movies, pre-stored files, slide shows, Flash™ animation, etc. can be used with features of the invention. The number and type of attributes or other data included in a vubbled video can vary as desired.

Many other types of hardware and software platforms can be used to implement the functionality described herein. For example, an authoring system or module can be included in a portable device such as a laptop, personal digital assistant (PDA), cell phone, game console, email device, etc. In such a system or module, various constituent components of the system might be included in a single device. In other approaches, one or more of the components or modules can be separable or remote from the others. For example, vubble data can reside on a storage device, server, or other device that is accessed over a network. In general, the functions described herein can be performed by any one or more devices, processes, subsystems, or components, at the same or different times, executing at one or more locations.

Generally, any type of playback device (e.g., computer system, set-top box, DVD player, etc.), image format (Motion Picture Experts Group (MPEG), Quicktime™, audio-visual interleave (AVI), Joint Photographic Experts Group (JPEG), motion JPEG, etc.), display method or device (cathode ray tube, plasma display, liquid crystal display (LCD), light emitting diode (LED) display, organic light emitting display (OLED), electroluminescent, etc.) can be used to implement embodiments of the present invention. Any suitable source can be used to obtain playback content such as a DVD, HD-DVD, Blu-ray™ Disc, hard disk drive, video compact disk (CD), fiber optic link, cable connection, radio-frequency transmission, network connection, and so on, may also be used. In general, the audio/visual content, display and playback hardware, content format, delivery mechanism and other components and properties of the system can vary, as desired, and any suitable items and characteristics can be used.

Any specific hardware and software described herein are only presented to provide a basic illustration of but one example of components and subsystems that can be used to achieve certain functionality such as playback of a video. It should be apparent that components and processes can be added to, removed from or modified from those shown in the Figures, or described in the text, herein.

Many variations are possible and many different types of DVD players or other systems for presenting audio/visual content can be used to implement the functionality described herein. For example, a video player can be included in a portable device such as a laptop, PDA, cell phone, game console, e-mail device, etc. The vubble data, i.e., video-tag data can reside on a storage device, server, or other device that is accessed over another network. In general, the functions described can be performed by any one or more devices, processes, subsystems, or components, at the same or different times, executing at one or more locations.

Accordingly, particular embodiments can provide for authoring and/or publishing tags in a video. The video can be played back via a computer, DVD player, or other device. The playback device may support automatically capturing of screen snapshots in the accommodation of tag information outside of a video play area. Further, while particular examples have been described herein, other structures, arrangements, and/or approaches can be utilized in particular embodiments. The formats for input and output video can be of any suitable type.

Any suitable programming language can be used to implement features of the present invention including, e.g., C, C++, Java, PL/I, assembly language, etc. Different programming techniques can be employed such as procedural or object oriented. The routines can execute on a single processing device or multiple processors. The order of operations described herein can be changed. Multiple steps can be performed at the same time. The flowchart sequence can be interrupted. The routines can operate in an operating system environment or as stand-alone routines occupying all, or a substantial part, of the system processing.

Steps can be performed by hardware or software, as desired. Note that steps can be added to, taken from or modified from the steps in the flowcharts presented in this specification without deviating from the scope of the invention. In general, the flowcharts are only used to indicate one possible sequence of basic operations to achieve a function.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

As used herein the various databases, application software or network tools may reside in one or more server computers and more particularly, in the memory of such server computers. As used herein, “memory” for purposes of embodiments of the present invention may be any medium that can contain, store, communicate, propagate, or transport the program for use by or in connection with the instruction execution system, apparatus, system or device. The memory can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment,” “an embodiment,” or “a specific embodiment” means that a particular feature, structure, or characteristic described in connection with the embodiment is included in at least one embodiment of the present invention and not necessarily in all embodiments. Thus, respective appearances of the phrases “in one embodiment,” “in an embodiment,” or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method, for linking video content to digital text messages, the method executed by a processor, the method comprising:
initiating composition of a digital text message;
receiving a signal from a user input device to select a digital video;
playing the digital video;
accepting one or more signals from a user input device to associate added text with a point in time of playback of the digital video; and
inserting a link into the digital text message, wherein the link allows selective accessing of information to associate the added text with the point in time of playback of the digital video.

2. The method of claim 1, wherein the link includes at least a portion of the added text.

3. The method of claim 1, wherein the link includes at least a portion of a frame of the video at or near the point in time of playback of the digital video.

4. The method of claim 1, further comprising:
determining a position of a cursor during composition of the digital text message at a time when the digital video is selected; and
inserting the link into the digital text message at the determined cursor position.

5. The method of claim 1, wherein the digital message includes an email message.

6. The method of claim 1, wherein the digital message includes a chat message.

7. The method of claim 1, wherein the digital message includes a Short Message Services (SMS) message.

8. The method of claim 1, further comprising:
displaying video transport controls for user navigation within the digital video; and
accepting signals from a user input device to define the added text at a point in time of playback of the digital video.

9. The method of claim 1, further comprising accepting signals from a user input device to define the added text at a position within a frame of the digital video.

10. An apparatus for linking video content to digital text messages, the apparatus comprising:
a processor;
a computer-readable storage medium including instructions executable by the processor for:
initiating composition of a digital text message;
receiving a signal from a user input device to select a digital video;
playing the digital video;
accepting one or more signals from a user input device to associate added text with a point in time of playback of the digital video; and
inserting a link into the digital text message, wherein the link includes information to associate the added text with the point in time of playback of the digital video.

11. A computer-readable storage medium including instructions executable by a processor for linking video content to an electronic message, the computer-readable storage medium comprising one or more instructions for:
initiating composition of an electronic message;
receiving a signal from a user input device to select a video;
playing the video;
accepting one or more signals from a user input device to associate added text with a point in time of playback of the video; and
inserting a link into the electronic message, wherein the link includes information to associate the added text with the point in time of playback of the video.

12. A method for handling video content associated with electronic messaging, the method comprising:
initiating an email session;
associating video content with the email session;
accepting a signal from a user input device to transition to a chat session;
entering a chat session in response to the signal; and
automatically displaying a reference to the video content within the chat session.
